(19) United States
(12) Patent Application Publication
(10) Pub. No.: US 2007/0070668 A1
(43) Pub. Date: Mar. 29, 2007

(54) Programmable electrical power systems and methods

(75) Inventors: Thomas H. Lynch, Chatsworth, CA (US); Erich H. Soendker, Granada Hills, CA (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/236,179

(22) Filed: Sep. 26, 2005

(51) Int. Cl. H02M 1/12; H02M 1/14

(52) U.S. Cl. 363/132; 363/40

(57) ABSTRACT

Systems and methods for programmable electrical power conversion are disclosed. In one embodiment, a programmable electrical power system includes an inverter apparatus selectively coupleable to a direct current energy source and adapted to receive a control signal, and operable to variably convert the direct current energy to a selected alternating current waveform based on the control signal. A processing unit is coupled to the inverter apparatus that is configured to provide the control signal to the inverter apparatus to variably control at least a frequency of the selected alternating current waveform.

### FIELD OF THE INVENTION

This invention relates generally to electrical power systems and methods, and more particularly, to systems and methods for the programmable configuration of electrical power systems.

### BACKGROUND OF THE INVENTION

In many applications, it is desirable to convert direct current (DC) power to alternating current (AC) power. For example, interruptible power supplies, fuel cells, photovoltaic panels, and other similar DC power sources often include power conversion devices so that AC power-consuming devices may be energized. In general, suitable power conversion devices for the foregoing systems are configured to accept a predetermined DC input level, and convert the input DC level to an AC waveform having a desired root mean square (RMS) voltage value, and a desired frequency. Accordingly, most presently available power conversion devices are configured to deliver an AC waveform at one frequency only, which usually conforms to a desired output frequency requirement (e.g., 50, 60 or 400 Hz).

Different power consumers may be configured to use AC power having different frequencies. For example, electrical systems for commercial and military aircraft are typically configured to generate and use AC power at 400 Hz, so that generally smaller and lighter electrical components may be used. Accordingly, ground supply units (e.g., motor-generator units) configured to convert DC power to AC power at 400 Hz cannot be used in other applications that require AC power at other frequencies.

Accordingly, what is needed in the art is a system and method for AC power conversion that avoids the shortcomings commonly associated with conversion systems that provide fixed frequency operation.

### SUMMARY

The present invention comprises systems and methods for programmable electrical power conversion. In one aspect, a programmable electrical power system includes an inverter apparatus selectively coupleable to a direct current (DC) energy source and adapted to receive a control signal, and operable to variably convert the direct current energy to a selected alternating current (AC) waveform based on the control signal. A processing unit is coupled to the inverter apparatus that is configured to provide the control signal to the inverter apparatus to variably control at least a frequency of the selected alternating current waveform.

### BRIEF DESCRIPTION OF THE DRAWINGS

Embodiments of the present invention are described in detail below with reference to the following drawings.

FIG. 1 is a block diagrammatic view of a programmable electrical power system according to an embodiment of the invention;

FIG. 2 is a block diagrammatic view of the inverter apparatus of FIG. 1, according to still another embodiment of the invention;

FIG. 3 is a schematic view of the switch of FIG. 2, according to an embodiment of the invention;

FIG. 4 is a graphical representation of a switch waveform that may be used with the system of FIG. 1;

FIG. 5 is a graphical representation of an output waveform from the inverter apparatus of FIG. 2 when the switch waveform of FIG. 4 is introduced to the apparatus;

FIG. 6 is a graphical representation of an output waveform from the inverter apparatus of FIG. 2;

FIG. 7 is a flowchart that describes a method for configuring a programmable electrical power system, according to yet another embodiment of the invention; and

FIG. 8 is a side elevation view of an aircraft having one or more of the disclosed embodiments of the present invention.

### DETAILED DESCRIPTION

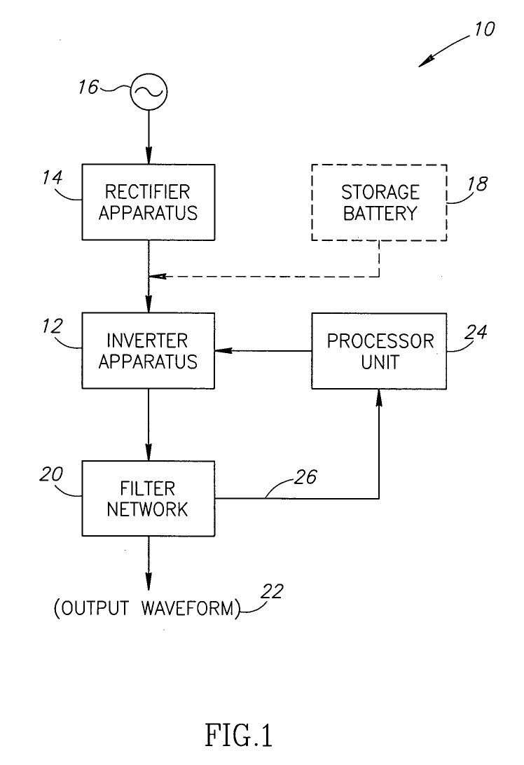

The present invention relates to electrical power systems and methods. Many specific details of certain embodiments of the invention are set forth in the following description and in FIGS. 1 through 7 to provide a thorough understanding of such embodiments. One skilled in the art, however, will understand that the present invention may have additional embodiments, or that the present invention may be practiced without one or more of the details described in the following description.

FIG. 1 is a block diagrammatic view of a programmable electrical power system 10 according to an embodiment of the invention. The system 10 includes an inverter apparatus 12 that is coupled to a selected direct current (DC) energy source, such as a rectifier apparatus 14 that is electrically coupled to an alternating current (AC) energy source 16. Alternately, the selected DC energy source may include one or more storage batteries 18. In either case, the inverter apparatus 12 is configured to receive DC energy and to convert the DC energy into a suitable AC waveform. The inverter apparatus 12 will be described in greater detail below.

In this embodiment, the inverter apparatus 12 is coupled to a filter network 20 that receives the AC waveform and filters the AC waveform to generate a desired output waveform 22. Accordingly, the filter network 20 may include any suitable combination of passive electrical elements including resistors, capacitors and inductors that are operable to suppress undesired harmonics present in the output waveform 22. Accordingly, in some embodiments, the passive electrical elements may be arranged to form any of the known Butterworth or Chebyshev configurations, which may further include any order sufficient to provide a desired degree of harmonic suppression, although other filter designs (e.g., Elliptic and Bessel configurations) are known and may also be used.

The system 10 also includes a processor unit 24 that is coupled to the inverter apparatus 12 and the filter network 20. The processor unit 24 may be any suitable digital computing device configured to receive programming instructions and input data, and to process the data according to the programming instructions. The processor unit 24 may be coupled to a plurality of external devices (not shown in FIG. 1), which may include a pointing device (or other suitable input device) operable to provide input commands to the processor unit 24, a keyboard for the entry of text information and commands into the processor unit 24, and a viewing screen for viewing information generated by the processor unit 24. Other external devices may include a printer operable to generate a printed copy of information generated by the processor unit 24, and a communications port that permits the processor unit 24 to communicate with still other devices and systems, such as in multiphase applications.

Still referring to FIG. 1, the processor unit 24 is operable to generate and store a switch drive waveform that may be communicated to the inverter apparatus 12 as a suitable logic level signal. For example, the logic level signals may be compatible with the known transistor-transistor logic (TTL), the known complementary metal oxide semiconductor (CMOS) logic, or other known logic systems. The switch drive waveform will be discussed in detail below in connection with the operation of the inverter apparatus 12. The processor unit 24 is also operatively coupled to the filter network 20 so that a feedback signal may be communicated to the processor unit 24. The feedback signal may be used to form an error signal that may be employed to regulate an amplitude, or other characteristics of the output waveform 22, as will be discussed in greater detail below.

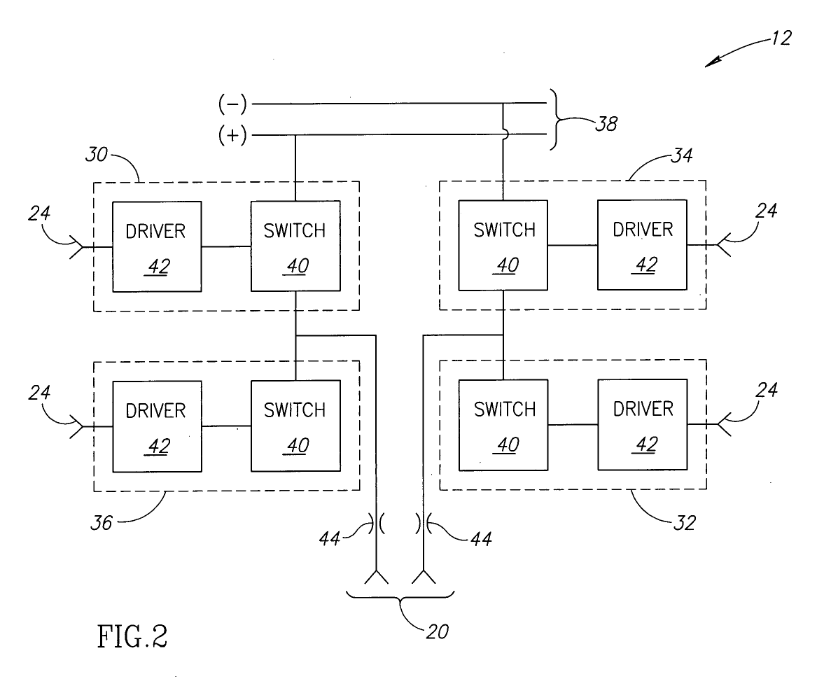

FIG. 2 is a block diagrammatic view of the inverter apparatus 12 of FIG. 1, according to another embodiment of the invention. The inverter apparatus 12 includes a first switching unit 30, a second switching unit 32, a third switching unit 34 and a fourth switching unit 36 that are operatively coupled to a selected DC energy source 38. The switching units 30, 32, 34 and 36 are also operatively coupled to the filter network 20 (FIG. 1) through a pair of feed-through capacitors 44 that are configured to suppress electromagnetic interference (EMI) that may be generated by the inverter apparatus 12. Alternately, the feed-through capacitors 44 may be coupled to the output of the filter network 20. In either case, the switching units 30, 32, 34 and 36 each include a switch 40 that is coupled to a driver 42. The switch 40 is generally operable to provide a high speed switching capability in response to an appropriate drive signal received from the driver 42. Accordingly, the driver 42 is configured to receive logic level signals from the processor unit 24 and to provide a signal that is suitable to command the switch 40 to open and/or close.

The operation of the inverter apparatus 12 will now be described. Upon receiving an appropriate signal from the processing unit 24, the drivers 42 in the first and second switch units 30 and 32 generate signals that are transferred to the respective switches 40. The switches 40 in the first and second switch units 30 and 32 are then actuated, and a positive waveform component is transferred to the filter network 20. When the signals to the first and second switching units 30 and 32 are interrupted, appropriate signals are transferred from the processing unit 24 to the third and fourth switch units 34 and 36 and a corresponding negative waveform component is transferred to the filter network 20. Accordingly, the foregoing procedure may be continued so that a periodic output waveform 20 (as shown in FIG. 1) is generated.

Although the periodic output waveform 20 may have any desired frequency by actuating the appropriate switch units 30, 32, 34 and 36 for a predetermined time period, in order to generate an output waveform 22 (as shown in FIG. 1) having a desired frequency, a switch drive waveform having a predetermined plurality of pulses having a desired pulse width and period may be transferred to the drivers 42 in the switch units 30, 32, 34 and 36. Accordingly, a selected pair of the first and second switch units 30 and 32, and the third and fourth switch units 34 and 36 are actuated when the switch drive waveform is communicated to the first and second switch units 30 and 32, and the third and fourth switch units 34 and 36, as will be described in greater detail below.

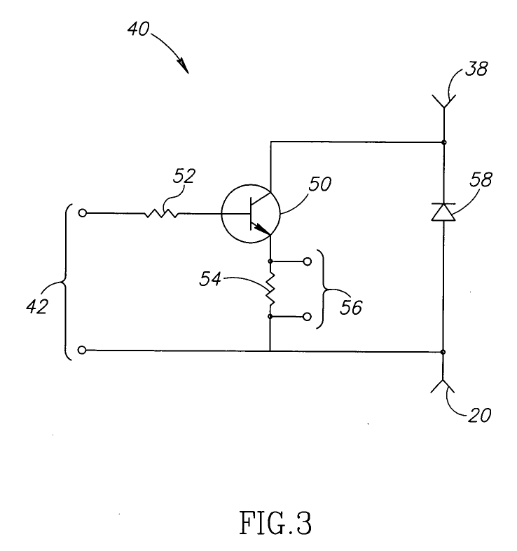

FIG. 3 is a schematic view of the switch 40 of FIG. 2, according to an embodiment of the invention. The switch 40 includes a semiconductor switching device 50 that receives an actuation signal from the driver 42 (as shown in FIG. 3) through a base resistor 52 and is correspondingly biased into a conductive state. Accordingly, a current is transferred from the DC energy source 38 and through a current measurement resistor 54 and further to an appropriate output terminal that is coupled to the filter network 20 (as shown in FIG. 1). The current measurement resistor 54 is operable to detect an over-current condition by providing a measurable voltage 56 at the resistor 54. The voltage 56 may be communicated to the processor unit 24 that is suitably configured to detect the corresponding voltage 56 and to determine if the voltage 56 corresponds to an over-current condition. When the over-current condition is detected, the processor unit 34 then instructs the system 10 of FIG. 1 to stop operation, either by interrupting a connection between the DC energy source 38 and the inverter apparatus 12, or by interrupting a transfer of the switch waveform to the drivers 42. Although a resistor 54 is described in the foregoing to detect an over-current condition, it is understood that a current transformer may also be used to detect the over-current condition. A shunt diode 58 is coupled across the semiconductor switching device 50 to provide commutation current for reactive loads that may be coupled to the device 50. Although FIG. 3 shows a bipolar junction transistor (BJT) configured as a n-p-n device, it is understood that the switching device 50 may be suitably configured to employ a BJT configured as a p-n-p device. Further, the semiconductor switching device 50 may also be a field effect transistor (FET), such as a metal oxide semiconductor (MOS) FET when the driver 42 is suitably configured to provide an actuation voltage to the FET.

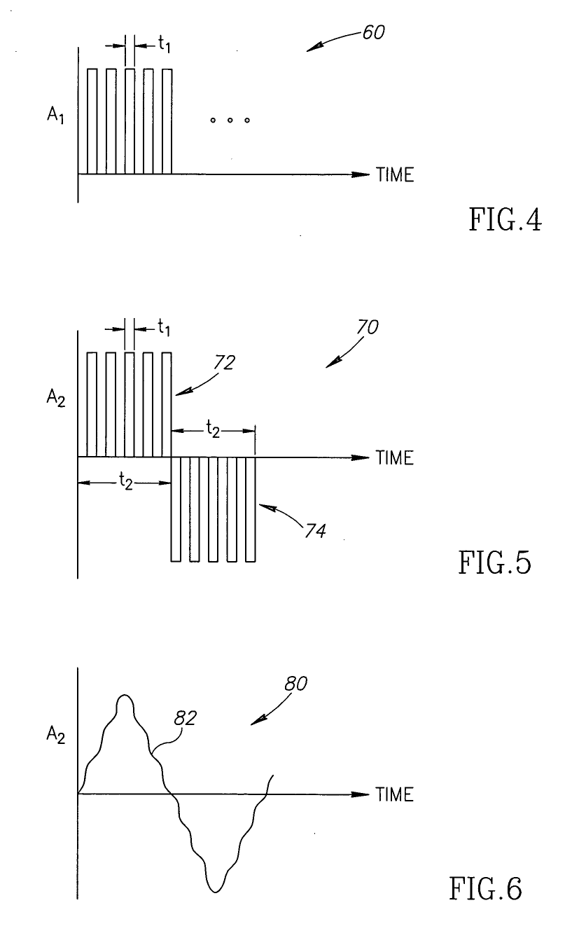

FIG. 4 is a graphical representation of a switch waveform 60 that may be used with the system 10 of FIG. 1. The waveform 60 includes a plurality of pulses having a predetermined amplitude A₁ that provides the required actuation to the drivers 42 (as shown in FIG. 2). Since various logic level signals may be used that correspond to different logic systems (e.g., TTL logic, CMOS logic, or other known logic systems) the amplitude A₁ corresponds to a voltage level consistent with the selected logic system. The waveform 60 also has a predetermined period t₁, which in a particular embodiment, may be approximately about ten microseconds (μ-s).

FIG. 5 is a graphical representation of a waveform 70 generated by the inverter apparatus 12 of FIG. 2 when the switch waveform 60 of FIG. 4 is introduced to the apparatus 12. The waveform 70 includes a first portion 72 that corresponds to the communication of a selected number of the pulses (corresponding to a time t₂) in the switch waveform 60 (as shown in FIG. 4) to the first and second switch units 30 and 32, and a second portion 74 that corresponds to the communication of an equivalent number of the pulses in the switch waveform 60 to the third and fourth switch units 34 and 36. Accordingly, the waveform 70 has a generally square-wave periodic shape having an amplitude A₂ and a period of 2 (t₂). It is readily seen that the waveform 70 may have various frequencies, which generally depends on the selected period t₂ of the switch waveform 60 of FIG. 4, and the selected number of pulses transferred to the respective first and second switch units 30 and 32, and the third and fourth switch units 34 and 36. Further, the processor unit 24 (as shown in FIG. 1) may be configured to transfer selected pulses from the switch waveform 60 of FIG. 4 to the first and second switch units 30 and 32, and the third and fourth switch units 34 and 36. In a specific embodiment, pulses may be selected from the switch waveform to generate an output waveform having a desired frequency. For example, when the switch waveform 60 includes 1000 pulses having a period of approximately about ten μ-s may be used to generate an output waveform 22 having a frequency of approximately about 50 Hz. By selectively eliminating each sixth pulse, an output waveform 22 having a frequency of approximately about 60 Hz may be generated. By selecting each eighth pulse (and eliminating the other pulses) an output waveform 22 having a frequency of approximately about 400 Hz may be generated.

FIG. 6 is a graphical representation of an output waveform 80 from the inverter apparatus 12 of FIG. 2. The waveform 80 results from subjecting the waveform 70 of FIG. 5 to the filter network 20 of FIG. 1. The waveform 80 has a generally sinusoidal shape at a selected frequency, and may also include a ripple component 82 that is superimposed on the waveform 80, which results from the pulsed shape of the waveform 70 of FIG. 5. The ripple component 82 may be reduced to a desired level by incorporating additional filter elements in the filter network 20. For example, the filter network 20 may be configured to include a higher-order passive filter network.

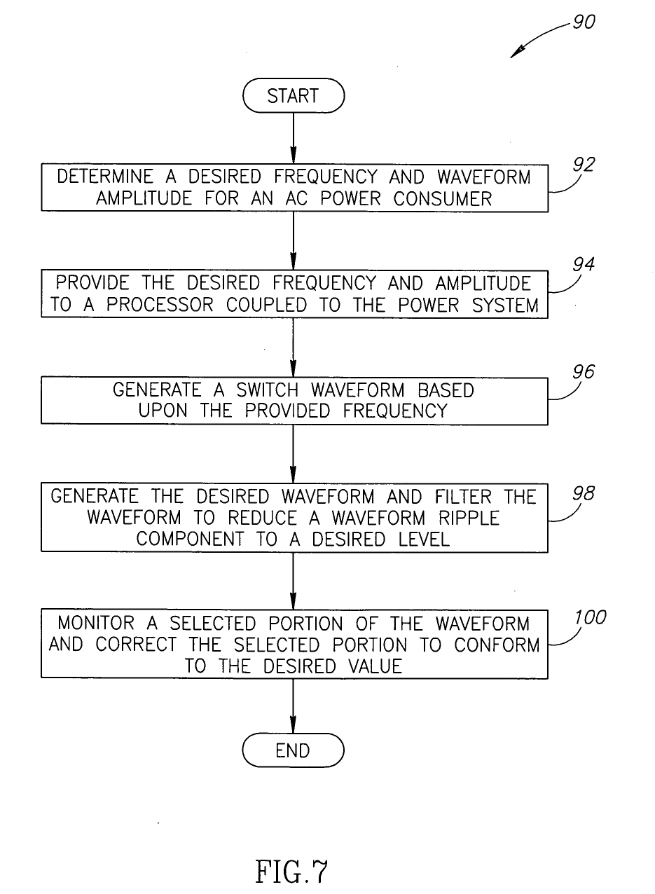

FIG. 7 is a flowchart that will be used to describe a method 90 for configuring a programmable electrical power system, according to yet another embodiment of the invention. At block 92, a desired frequency and waveform amplitude is determined. For example, an AC power consumer may require AC power at 60 Hz, and 208 volts (RMS). Alternately, the AC power consumer may require AC power at 400 Hz, and 115 volts (RMS), or still other commonly encountered frequencies and/or waveform amplitudes. At block 94, the desired frequency and amplitude is provided to a processor unit coupled to the power system. A switch waveform is generated by the processor based upon the provided frequency, as shown at block 96. For example, in one disclosed embodiment, the switch waveform includes a plurality of pulses that are spaced approximately about ten μ-s apart. At block 98, the desired waveform is generated from the switch waveform. The desired waveform may then be filtered in order to reduce a ripple component to a desired level. At block 100, a selected portion of the generated waveform is monitored and if the selected portion deviates from a desired value, the processor unit corrects the waveform portion. For example, in one disclosed embodiment, a waveform amplitude is monitored and an error is generated based upon a difference between a desired amplitude and the monitored amplitude. If the error is greater than a predetermined threshold value, the monitored waveform amplitude is corrected to yield a value closer to the desired amplitude. In another specific embodiment, output values from selected locations in the inverter apparatus may be monitored, and if the output values exceed a predetermined value, the processor unit interrupts the operation of the power system.

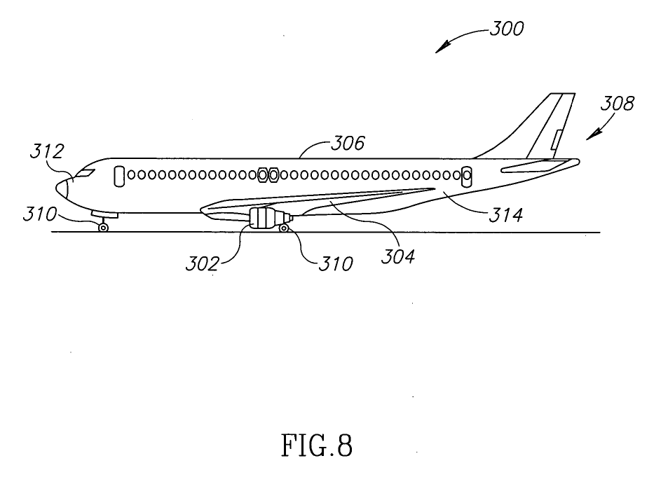

The foregoing embodiments may be incorporated into a wide variety of different systems. Referring now to FIG. 8, a side elevation view of an aircraft 300 having one or more of the disclosed embodiments of the present invention is shown. With the exception of the embodiments according to the present invention, the aircraft 300 includes components and subsystems generally known in the pertinent art. For example, the aircraft 300 generally includes one or more propulsion units 302 that are coupled to wing assemblies 304, or alternately, to a fuselage 306 or even other portions of the aircraft 300. Additionally, the aircraft 300 also includes a tail assembly 308 and a landing assembly 310 coupled to the fuselage 306. The aircraft 300 further includes a flight control system 312 (not shown in FIG. 4), as well as a plurality of other electrical, mechanical and electromechanical systems that cooperatively perform a variety of tasks necessary for the operation of the aircraft 300.

Accordingly, the aircraft 300 is generally representative of a commercial passenger aircraft, which may include, for example, the 737, 747, 757, 767 and 777 commercial passenger aircraft available from The Boeing Company of Chicago, Ill. Although the aircraft 300 shown in FIG. 8 generally shows a commercial passenger aircraft, it is understood that the various embodiments of the present invention may also be incorporated into flight vehicles of other types. Examples of such flight vehicles may include manned or even unmanned military aircraft, rotary wing aircraft, or even ballistic flight vehicles, as illustrated more fully in various descriptive volumes, such as Jane's All The World's Aircraft, available from Jane's Information Group, Ltd. of Coulsdon, Surrey, UK. In addition, various embodiments of the present invention may also be incorporated into other transportation vehicles of various types, which may include terrestrial vehicles.

With reference still to FIG. 8, the aircraft 300 may include one or more of the embodiments of the programmable power conversion system 314 according to the present invention which may operate in association with the various systems and sub-systems of the aircraft 300, including, for example, an electrical power supply system that provides power to the passenger cabin of the aircraft 300 for use by the passengers, or to other various systems and subsystems of the aircraft 300. In addition, in still other embodiments, the programmable power conversion system 314 may be a separate system that may be remotely positioned relative to the aircraft 300 and coupled to the aircraft 300 using suitable metallic conductors, such as during servicing, maintenance, or other ground-based operations.

While various embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A programmable electrical power system, comprising:
an inverter apparatus selectively coupleable to a direct current energy source and adapted to receive a control signal, and operable to variably convert the direct current energy to a selected alternating current waveform based on the control signal; and
a processing unit coupled to the inverter apparatus that is configured to provide the control signal to the inverter apparatus to variably control at least a frequency of the selected alternating current waveform.

2. The system of claim 1, further comprising a direct current energy source including at least one of a rectifier that is coupled to a suitable alternating current energy source, and a storage battery.

3. The system of claim 1, further comprising a filter network coupled to the inverter apparatus that is operable to selectively alter the harmonic content of the alternating current waveform.

4. The system of claim 3, wherein the filter network further comprises a selected combination of passive filter elements.

5. The system of claim 4, wherein the passive filter network further comprises one of a Butterworth, a Chebyshev, an Elliptic and a Bessel filter configuration.

6. The system of claim 3, wherein the processing unit is further coupled to the filter network and configured to control a frequency and an amplitude of the alternating current waveform.

7. The system of claim 1, wherein the processing unit is configured to generate and store a switching waveform, and further wherein the inverter apparatus comprises a plurality of switching units that are responsive to the switching waveform.

8. The system of claim 7, wherein the switching waveform comprises a plurality of pulses having a uniform spacing and an amplitude that conforms to a selected logic system.

9. The system of claim 8, wherein the pulses have a spacing of approximately about ten microseconds, and the amplitude conforms to a transistor-transistor (TTL) logic level.

10. The system of claim 7, wherein the plurality of switching units further comprise semiconductor switching units that include one of a bipolar junction transistor (BJT) and a field effect transistor (FET).

11. The system of claim 7, wherein the processing unit is further operable to detect an over-current condition in at least one of the switching units and to interrupt the operation of the system when the condition is detected.

12. A method of configuring an electrical power conversion system that is operable to convert direct current energy to a desired alternating current output, comprising:
coupling the system to a direct current energy source;
providing a desired frequency for the alternating current output to a processing unit;
generating a switching waveform based upon the provided frequency that includes a plurality of uniformly spaced pulses having a predetermined amplitude; and
providing the switching waveform to a plurality of switching units operable to generate the desired alternating current output by intermittently conducting the direct current energy.

13. The method of claim 12, wherein coupling the system to a direct current energy source further comprises coupling the system to one of a rectified alternating current and a storage battery.

14. The method of claim 12, wherein determining a desired frequency further comprises determining a desired amplitude for the output waveform.

15. The method of claim 12, wherein generating a switching waveform based upon the provided frequency further comprises producing a switching waveform having a pulse spacing of approximately about ten microseconds, and an amplitude that is compatible with a selected logic.

16. The method of claim 12, further comprising filtering the alternating current output to obtain a desired harmonic content.

17. The method of claim 12, further comprising:
detecting a current level in at least of the switching units; and
interrupting operation of the system if the current level exceeds a predetermined value.

18. The method of claim 12, further comprising:
monitoring an amplitude of the alternating current output;
computing an error based upon a difference between a desired amplitude and the monitored amplitude; and
correcting the amplitude to reduce the computed error.

19. An aerospace vehicle, comprising:
a fuselage;
wing assemblies operatively coupled to the fuselage;
at least one propulsion unit coupled to at least one of the fuselage and the wing assemblies; and
an electrical power conversion system operatively disposed within at least one of the fuselage and wing assemblies, including:
an inverter apparatus selectively coupleable to a direct current energy source and adapted to receive a control signal, and operable to variably convert the direct current energy to a selected alternating current waveform based on the control signal; and
a processing unit coupled to the inverter apparatus that is configured to provide the control signal to the inverter apparatus to variably control at least a frequency of the selected alternating current waveform.

20. The aerospace vehicle of claim 19, further comprising a direct current energy source coupled to the electrical power conversion system and including at least one of a rectifier that is coupled to a suitable alternating current energy source, and a storage battery.

21. The aerospace vehicle of claim 19, further comprising a filter network coupled to the inverter apparatus that is operable to selectively alter the harmonic content of the alternating current waveform.

22. The aerospace vehicle of claim 19, wherein the processing unit is configured to generate and store a switching waveform, and further wherein the inverter apparatus comprises a plurality of switching units that are responsive to the switching waveform.
